(19) United States
(12) Patent Application Publication
(10) Pub. No.: US 2013/0282600 A1
(43) Pub. Date: Oct. 24, 2013

(54) Pattern Based Audit Issue Reporting

(71) Applicant: Ying Zeng, Fremont, CA (US)

(72) Inventor: Ying Zeng, Fremont, CA (US)

(73) Assignee: SAP AG, Walldorf (DE)

(21) Appl. No.: 13/453,187

(22) Filed: Apr. 23, 2012

(51) Int. Cl. G06Q 10/06

(52) U.S. Cl. 705/317

(57) ABSTRACT

A computer system receives an audit report from an audit proceeding. Predefined patterns are recognized in the audit report. One or more audit issues may be associated with each recognized pattern. Suitable remedial action may be generated for each identified audit issue, and dispatched to one or more actors who are then responsible for attending to the remedial action.

### BACKGROUND

Unless otherwise indicated herein, the approaches described in this section are not prior art to the claims in this application and are not admitted to be prior art by inclusion in this section.

Audits are common activities in an organization, such as a business enterprise. Audits cover a broad range of practices in the organization, including financial audits, operational systems audits, manufacturing audits, compliance audits, information systems audits, and so on. There are many goals of an audit: add credibility to the financial health of an organization, assure customers of the quality of the goods or services provided by an organization, assure governmental and other regulatory agencies that the organization is in compliance and applicable laws and regulations, and so on. Accordingly, it is important that the quality and reliability of an audit is high.

During an audit proceeding, many facts need to be documented. An auditor typically identifies numerous issues during the course of conducting the auditing process. Many issues may arise that require follow up investigation. However, the auditor has limited time to perform their audit and thus cannot attend to each circumstance until after they have completed the audit. Instead, the auditor typically needs to log onto an auditing system to log their report and to log any issues they spotted during the audit process. Accordingly, an auditor's work does not end with the auditing process, but may continue well after the actual auditing has completed.

### BRIEF DESCRIPTION OF THE DRAWINGS

FIG. 1 shows an illustrative embodiment of the present disclosure.

FIG. 2 shows processing in accordance with the present disclosure.

FIG. 3 shows an illustrative example of a pattern map in accordance with the present disclosure.

FIG. 4 shows an illustrative example of a computer system embodiment.

### DETAILED DESCRIPTION

In the following description, for purposes of explanation, numerous examples and specific details are set forth in order to provide a thorough understanding of the present disclosure. It will be evident, however, to one skilled in the art that the present disclosure as defined by the claims may include some or all of the features in these examples alone or in combination with other features described below, and may further include modifications and equivalents of the features and concepts described herein.

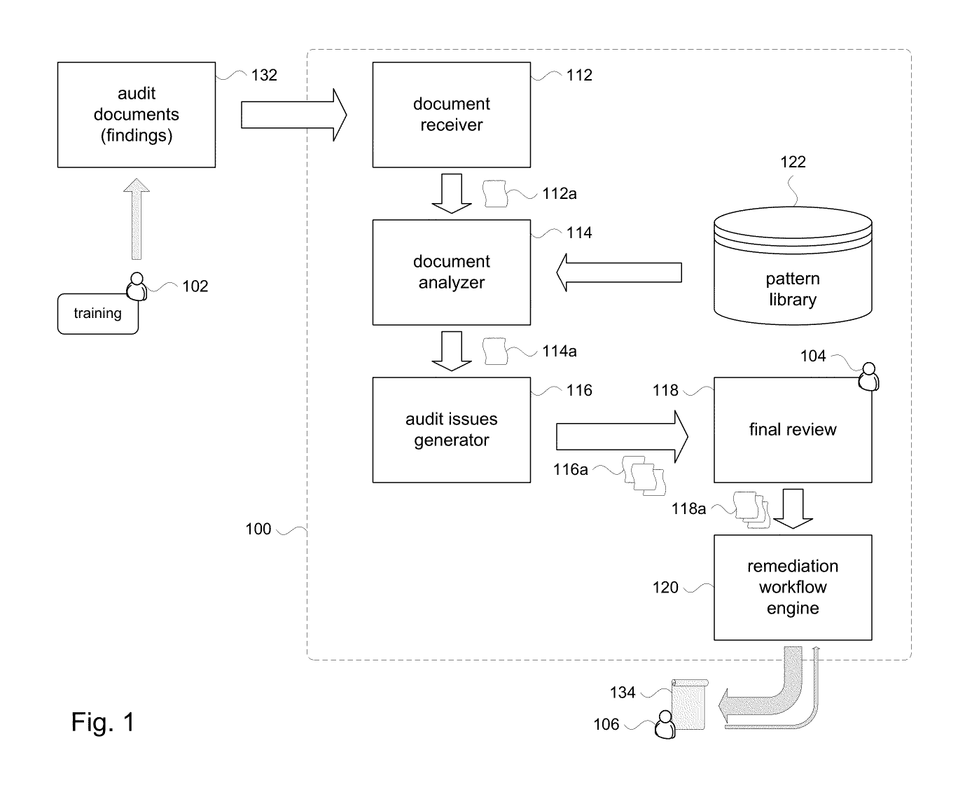

FIG. 1 shows a system 100 in accordance with embodiments of the present disclosure for an audit proceeding (audit process, audit) of an organization, and in particular the system may facilitate the activity that takes place after the actual audit has completed. The system 100 receives the findings (“audit documents”) 132 of an audit conducted by an auditor 102. In accordance with principles of the present disclosure, the audit may be for any aspect of operations or activities conducted by the organization, including but not limited to financial audits, audits for compliance with regulatory agencies (government, industry practice, etc.), audits of the organization's infrastructure (e.g., information systems), audits on goods and/or services offered by the organization, and so on.

The audit documents 132 may be handwritten material made by the auditor 102. In some embodiments, the audit documents 132 may include pre-printed material that guide or otherwise inform the auditor 102 of the audit process (e.g., multiple choice check list, checkbox check list, etc.). The audit documents 132 may include electronic information. For example, the auditor 102 may use a computing device (e.g., a computer tablet) or other electronic device to record or otherwise gather information during the audit process. In some embodiments, the audit documents 132 may include images (e.g., digital camera), voice recordings, and so on generated during the audit process.

In accordance with the present invention, the auditor 102 may be trained to incorporate into the audit documents 132 certain “patterns” of key words and/or markings. The patterns, for example, may be incorporated into written material, or may be spoken into a recording device. As will be explained below, the patterns may be used to identify issues that need further investigation or some form of follow up activity.

In some embodiments, the system 100 may produce a remediation workflow 134 based on an analysis of the audit documents 132. The remediation workflow 134 provides a framework and steps for resolving audit issues identified from the audit documents 132. The remediation workflow 134 may be assigned to or otherwise designate one or more stakeholders 106 who are given responsibility for processing the remediation workflow to resolve the audit issue(s). The term “audit issue” will be understood to refer to actual issues (e.g., fraudulent accounting numbers) and audit-related matters such as violations of established practice (e.g., laws, regulations, policies, etc.), relevant people (e.g., department managers, customers, etc.), and so on.

The system 100 may comprise a document receiver 112 which receives the audit documents 132 produced or otherwise collected by the auditor 102. The document receiver 112 may then extract information 112a from the received documents 132 that is then processed by the system 100. A document analyzer 114 may analyze the extracted information 112a and produce analyzed data 114a. A pattern library 122 may inform the analysis during the analysis. An audit issues generator 116 may receive the analyzed data 114a and from the data identify proposed audit issues which may be stored in audit issue data objects 116a. A final reviewing module 118 may receive the proposed audit issue data objects 116a and may interact with a user 104 to review and revise the proposed audit issues to produce finalized audit issue data objects 118a. A remediation workflow engine 120 may then trigger appropriate remediation workflow(s) along with one or more suitable stakeholders 106, based on the audit issue data objects 118a.

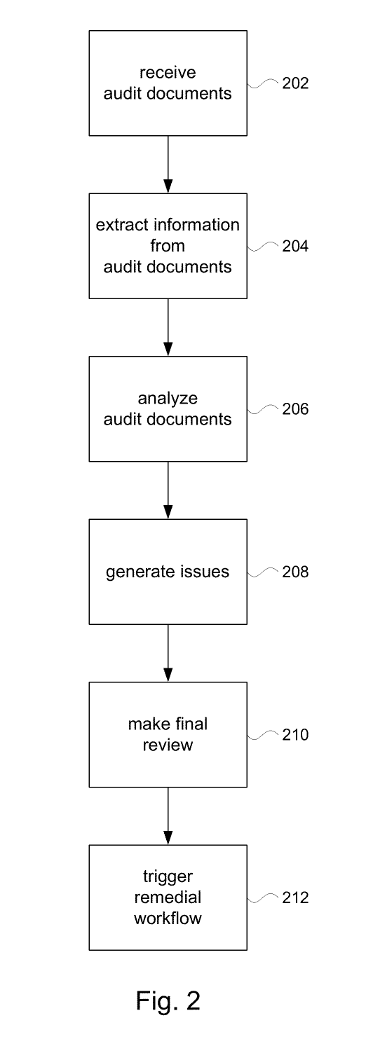

Referring to FIGS. 1 and 2, additional details of the system 100 will be explained in terns of processing by the system. At a step 202, an auditor 102 may submit the results of their audit to the system 100 as audit documents 132, where the audit documents are received by the document receiver 112. The audit documents 132 may come in any suitable data format. The audit documents 132 may be handwritten or printed documents, images, audio recordings, and so on.

In a step 204, the document receiver 112 may process the received audit documents 132 to obtain extracted information 112a from the audit documents that the rest of the system 100 can use. In some embodiments, the document receiver 112 may include various information processing components. For example, the received audit documents 132 may be scanned and optical character recognition (OCR) may be performed to produce textual data from the scanned audit documents. If audit documents 132 contain audio recordings, then speech recognition processing may be performed to produce textual data from the voice recordings. In some embodiments, image processing may also be performed to identify extracted images, pictures, drawings, and the like that the auditor 102 may have included in their audit documents 132 as part of the audit process. The extracted information may therefore comprise image data as well as the textual data.

In a step 206, the extracted information 112a may then be analyzed by the document analyzer 114 to identify one or more issues that the auditor 102 identified during the course of the audit. In some embodiments, the textual data may be analyzed to identify keywords, key phrases, or other text patterns (collectively “patterns”). The auditor 102 may be trained to use certain keywords, key phrases, and other such predefined markings for various categories of issues. For example, the auditor 102 may be trained to use the keyword “concern” in their notes (audit documents 132); thus, they may write down something like “This is a big concern some employees invite potential customer for dinner and give them gift over $1000”. In embodiments, the auditor 102 may be trained to use the keywords in certain patterns in order to capture additional information. In some embodiments, for example, regular expressions may be used to define a pattern such as:
concern {.*}
   Thus, if the auditor 102 writes down “This is a big concern {some employees invite potential customer for dinner and give them gift over $1000}”, the document analyzer 114 may match two strings: “concern” and “{some employees invite potential customer for dinner and give them gift over $1000}”. The document analyzer 114 may then output a token identifier for the string “concern” and another token identifier for “{some employees invite potential customer for dinner and give them gift over $1000}”. The pattern library 122 may contain several such patterns to represent the predefined markings that the auditor 102 may make. The document analyzer 114 may produce a list of such tokens from its analysis of the extracted information 112a to produce the analyzed data 114a.

In addition to issues per se, the auditor 102 may be trained to call out other audit related information. For example, the auditor 102 may recognize that a particular issue should be handled by a particular person, or that a particular practice (law, regulation, policy, etc.) is applicable and should be called up. Thus, the pattern library 122 may include patterns such as:
responsible manager {.*}
mitigation method {.*}
   and so on. The auditor 102 may then write in their notes something like “This should be handle be handled by the responsible manager {David Tim}”, or “We should consider using mitigation method {code of conduct policy} to address this situation”.

In some embodiments, the extracted information 112a may include image data in addition to the textual data. As explained, the textual data may be analyzed (e.g., using regular expressions) to identify keywords, key phrases, and any related additional data. Image data may be also analyzed. Predefined images also be stored in the pattern library 122. Using suitable image processing and image recognition tools, image data in the extracted information 112a may be matched against the predefined images in the pattern library 122 to identify any predefined images or other non-textual markings that the auditor 102 may make. Any identified images may then be tokenized as discussed above and added to the analyzed data 114a.

It can be appreciated that in accordance with principles of the present disclosure, the auditor 102 may be trained to use certain patterns of text containing keywords or key phrases to identify audit issues. In some embodiments, graphic symbols may be used in addition to text. Thus, when the auditor 102 recognizes an issue, they may make an appropriate notation in their notes that corresponds to the issue. For example, suppose during the course of an audit of an organization's sales accounts, the auditor 102 felt that certain gifts to a customer seemed excessive, the auditor may put into their notes something like “Concern {gift of diamond ring from salesman Tom Jones seems excessive}”, where the auditor 102 has been trained to use the keyword “concern” for such a situation. Alternatively, the auditor 102 may write down “gift of diamond ring from salesman Tom Jones seems excessive” and draw a box graphic around the text. Suitable image processing analysis may be provided to identify the presence of the box, and then perform OCR processing on the contents of the box.

In a step 208, one or more audit issue data objects 116a may be generated from the analyzed data 114a. In some embodiments, several classes of audit issue data objects 116a may be defined to contain the various types of audit issues that may be identified during the audit process. The pattern library 122 may include a table that maps predefined patterns and markings to various audit issues. The audit issue data objects 116a store information in a way that the system 100 can process the identified audit issues. For each audit issue identified, an audit issue data object 116a may be created to store information (attributes) relating to the identified audit issue.

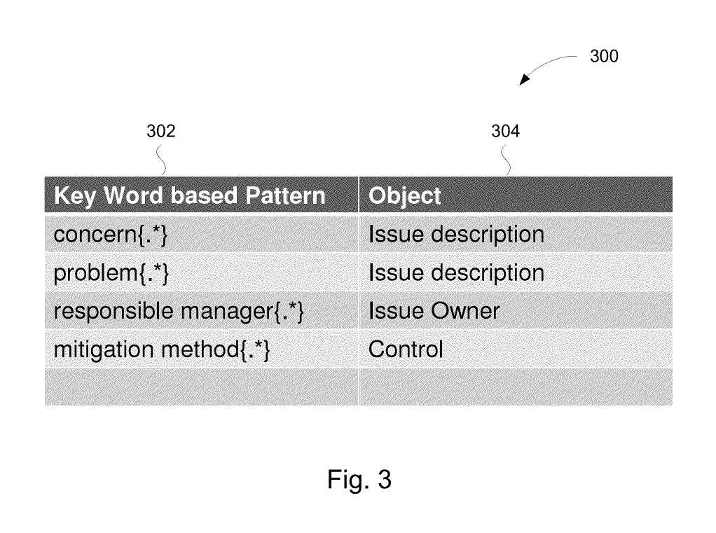

Referring to FIG. 3 for a moment, an example of a mapping table 300 is shown. A keyword pattern column 302 specifies predefined patterns to look for in the analyzed data 114a. An object column 304 designates which class of data objects to use for each predefined pattern. Thus, for example, the keyword “concern” may map to an “issue description” data object for handling audit issues. The data object may store the additional information associated with the “concern” keyword. In our running example, the additional information “{some employees invite potential customer for dinner and give them gift over $1000}” may be stored in the data object. The data object may include other information such as the name of the auditor 102, when the audit was conducted, and so on. The data object may identify a person who is responsible for handling the specific issue, or may identify a specific workflow for handling this type of issue. As another example, the “responsible manager” keyword may map to an “issue owner” data object. This may include an identity of the manager, their contact information, and so on. The “mitigation method” keyword may map to a “control” data object. This type of data object may include a reference to relevant documents (e.g., company policy, laws, etc.), may link to a workflow that must be performed, may identify a responsible person who is given responsibility of ensuring the workflows has been processed. The data object may identify necessary personnel who must participate in the workflow, may identify a hierarchy of management personnel who must sign off on the workflow, and so on. It can be appreciated the data objects may contain any kind of information that may be needed in order to address the particular audit issue at hand.

Returning to FIG. 2 step 208, for each audit issue identified, an audit issue data object 116a may be created to store information (attributes) relating to the identified audit issue. For example, an audit issue object data 116a may comprise attributes such as:
Description
Suspicious Activity
Suspicious
Priority
Issue Type
Due date
Responsible person
Issue owner
Related documents/links, and so on
   Information for these attributes may be identified from the audit documents 132, for example using keywords and other patterns in the pattern library 122. In addition, information from personnel databases, policy/regulation databases, and any other relevant information sources may be used to fill in the attributes.

In some embodiments, each audit issue and its corresponding audit issue data object 116a may be routed to an audit issue owner 104 (e.g., via email). The audit issue owner 104 may be identified in step 208 at the time the audit issue data object 116a is created. The audit issue owner 104 may review the details of the audit issue assigned to them, and may add, remove, modify, or otherwise refine the information in the audit issue data object. A finalized audit issue data object 118a is then produced.

In a step 212, each finalized audit issue data object 118a serves to trigger the remediation workflow engine 120. The audit issue data object 118a may be processed by the remediation workflow engine 120 to deliver various content (e.g., remediation workflow 134) relating to remediation of the audit issue. At this point, the audit issue data object 118a is deemed to be self-contained in that one or more audit issues have been identified, and relevant documents and actors for each audit issue have been identified and confirmed by a reviewer (step 210). The content may be delivered to one or more stakeholders who have responsibility in taking proper remedial action on the audit issues contained in each audit issue data object 118a. The stakeholders may be identified in step 208 and/or in step 210, and identified in the audit issue data object 118a. The stakeholders may be contacted by receiving an email with relevant workflow instructions, meeting notices may be sent out, and so on. The stakeholders may then go out and conduct the activity(ies) required of them. The audit issue data object 118a may include a checklist or other criteria that must be met to “close out” each audit issue that comprises the audit issue data object. For example, the remediation workflow engine 120 may require certain actors to acknowledge receipt of workflow action item, confirm completion of an action item, and so on. The remediation workflow engine 120 may impose time constraints, requiring some action items to be completed in a specified period of time. As each audit issue is deemed to be remedied, the remediation workflow engine 120 may signal an administrator of the completion; e.g., human resources. In other embodiments, issue completion may be not be signaled until each audit issue in the audit issue data object 118a has been completed.

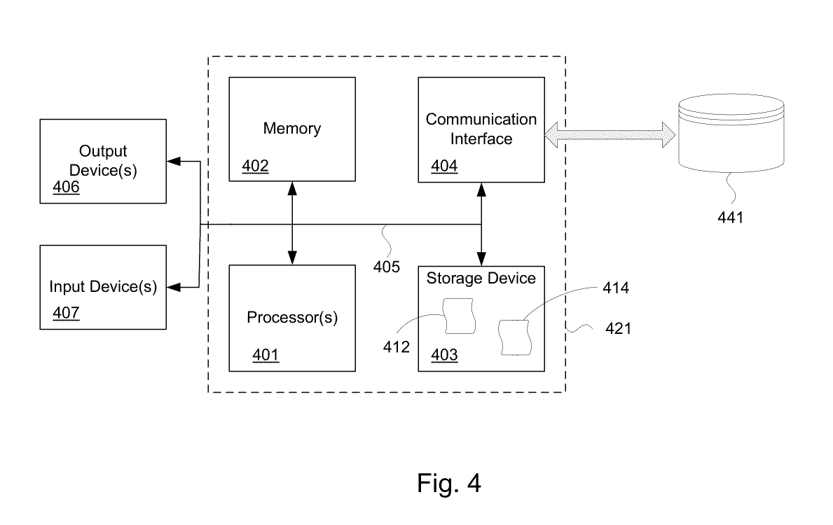

FIG. 4 is a block diagram of a computer system 421 according to some embodiments. The computer system 421 may be configured as a general purpose computing apparatus and may execute program code to perform one or more of the processing steps shown in FIG. 2. The computer system 421 may include, among its components, a processor component 401 (which may comprise one or more central processing units) operatively coupled to a communication interface 404, a data storage device 403, one or more input devices 407, one or more output devices 406, and a memory 402. The communication interface 404 may facilitate communication on a communication network to access other systems, such as storage system 441 for example. In an embodiment, the storage system 441 may serve as the pattern library 122.

Input device(s) 407 may include, for example, a keyboard, a keypad, a mouse or other pointing device, a microphone, knob or a switch, an Infra-Red (IR) port, a docking station, a touch screen, and so on. Input device(s) 407 may be used by auditor 102 to initiate automated audit processing as set forth in the present disclosure. Output device(s) 406 may include, for example, a display (e.g., a display screen), a speaker, a printer, and so on. Additional elements (not shown) may be including according to some embodiments.

The data storage device 403 may comprise any appropriate persistent storage device, including combinations of magnetic storage devices (e.g., magnetic tape, hard disk drives and flash memory), optical storage devices, Read Only Memory (ROM) devices, etc., while memory 402 may comprise Random Access Memory (RAM).

The data storage device 403 may store program code 412 which may be executed by the processor component 401 to cause the computer to perform any one or more of the process steps of FIG. 2. Embodiments are not limited to execution of these processes by a single apparatus. The data storage device 403 may store data structures 414 such as audit issue data objects. The data storage device 403 may also store data and other program code for providing additional functionality and/or which are necessary for operation thereof, such as device drivers, operating system files, etc.

All systems and processes discussed herein may be embodied in program code stored on one or more non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. It will be appreciated that embodiments are not limited to any specific combination of hardware and software. Elements described herein as communicating with one another are directly or indirectly capable of communicating over any number of different systems for transferring data, including but not limited to shared memory communication, a local area network, a wide area network, a telephone network, a cellular network, a fiber-optic network, a satellite network, an infrared network, a radio frequency network, and any other type of network that may be used to transmit information between devices. Moreover, communication between systems may proceed over any one or more transmission protocols that are or become known, such as Asynchronous Transfer Mode (ATM), Internet Protocol (IP), Hypertext Transfer Protocol (HTTP) and Wireless Application Protocol (WAP).

### ADVANTAGES AND TECHNICAL EFFECT

An audit proceeding in an organization can become document and data intensive as the quality of the audit can be affected by the thoroughness of the auditor and completeness of the data that is collected. Issues which arise during the audit process are typically handled back at the auditor's office. The present disclosure provides an automated process to facilitate the handling of audit issues identified during the audit process. The present disclosure allows for consistent handling of similar issues, can ensure that all parties responsible for a particular audit issue become involved and complete any tasks assigned to them.

The above description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents will be evident to those skilled in the art and may be employed without departing from the spirit and scope of the disclosure as defined by the claims.

What is claimed is:

1. A method comprising:
receiving one or more audit documents produced during an audit;
identifying one or more predefined markings from the one or more audit documents;
generating at least one audit issue object comprising one or more attributes, each attribute associated with one of the predefined markings and comprising information contained in the one or more audit documents associated with the predefined marking;
identifying a recipient based on information comprising the audit issue object;
identifying a workflow associated with the audit issue object; and
sending the workflow to the recipient.

2. The method of claim 1 wherein the predefined markings comprise predefined patterns of text.

3. The method of claim 2 wherein the predefined patterns of text comprise predefined key words or predefined word phrases.

4. The method of claim 1 wherein the predefined markings comprise predefined graphical symbols.

5. The method of claim 1 further comprising performing optical character recognition to identify textual data in the one or more audit documents and identifying predefined patterns of text among the textual data.

6. The method of claim 1 further comprising performing speech recognition to identify textual data in the one or more audit documents and identifying predefined patterns of text among the textual data.

7. The method of claim 1 wherein identifying one or more predefined markings includes performing pattern recognition using regular expressions.

8. A computer system comprising:
a computer;
a storage system; and
computer executable program code, which when executed by the computer, causes the computer to:
receive one or more audit documents produced during an audit;
identify one or more predefined markings from the one or more audit documents;
generate at least one audit issue object comprising one or more attributes, each attribute associated with one of the predefined markings and comprising information contained in the one or more audit documents associated with the predefined marking;
identify a recipient based on information comprising the audit issue object;
identify a workflow associated with the audit issue object; and
send the workflow to the recipient.

9. The computer system of claim 8 wherein the predefined markings comprise predefined patterns of text.

10. The computer system of claim 9 wherein the predefined patterns of text comprise predefined key words or predefined word phrases.

11. The computer system of claim 8 wherein the predefined markings comprise predefined graphical symbols.

12. The computer system of claim 8 wherein execution of the computer executable program code further causes the computer to perform optical character recognition to identify textual data in the one or more audit documents and identify predefined patterns of text among the textual data.

13. The computer system of claim 8 wherein execution of the computer executable program code further causes the computer to perform speech recognition to identify textual data in the one or more audit documents and identify predefined patterns of text among the textual data.

14. A non-transitory computer readable storage medium comprising computer executable program code, which when executed by a computer, causes the computer to perform steps of:
receiving one or more audit documents produced during an audit;
identifying one or more predefined markings from the one or more audit documents;
generating at least one audit issue object comprising one or more attributes, each attribute being associated with one of the predefined markings and comprising information contained in the one or more audit documents associated with the predefined marking;
identifying a recipient based on information comprising the audit issue object;
identifying a workflow associated with the audit issue object; and
sending the workflow to the recipient.

15. The non-transitory computer readable storage medium of claim 14 wherein the predefined markings comprise predefined patterns of text.

16. The non-transitory computer readable storage medium of claim 15 wherein the predefined patterns of text comprise predefined key words or predefined word phrases.

17. The non-transitory computer readable storage medium of claim 14 wherein the predefined markings comprise predefined graphical symbols.

18. The non-transitory computer readable storage medium of claim 14 further comprising performing optical character recognition to identify textual data in the one or more audit documents and identifying predefined patterns of text among the textual data.

19. The non-transitory computer readable storage medium of claim 14 further comprising performing speech recognition to identify textual data in the one or more audit documents and identifying predefined patterns of text among the textual data.

20. The non-transitory computer readable storage medium of claim 14 wherein identifying one or more predefined markings includes performing pattern recognition using regular expressions.
